(19) United States
(12) Patent Application Publication
(10) Pub. No.: US 2009/0222495 A1
(43) Pub. Date: Sep. 3, 2009

(54) Method for Managing the Versions of Automation Data for a Power Station Automation System

(76) Inventors: Dieter Kleyer, Herzogenaurach (DE); Raimund Nolte, Finnentrop (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/227,720

(22) PCT Filed: Jan. 18, 2007
(86) PCT No.: PCT/EP2007/050501

§ 371 Date: May 20, 2009

(30) Foreign Application Priority Data
May 26, 2006 (EP) 06010969.1

(51) Int. Cl. G06F 17/30

(52) U.S. Cl. 707/203; 707/E17.032; 707/E17.005

(57) ABSTRACT

The invention relates to a method for managing the version of automation data in a power plant automation system which are stored in different stores on platforms of the power plant automation system which are networked to one another, in which versions of at least one data item of the automation data are exported into an interoperable format using a suitable tool and the versions which are in the form of an interoperable format are managed using a version management system.

### CROSS REFERENCE TO RELATED APPLICATIONS

This application is the US National Stage of International Application No. PCT/EP2007/050501, filed Jan. 18, 2007 and claims the benefit thereof. The International Application claims the benefits of European application No. 06010969.1 filed May 26, 2006, both of the applications are incorporated by reference herein in their entirety.

### FIELD OF INVENTION

The invention relates to a method for managing the versions of automation data for a power station automation system, the data being held in different data stocks on platforms of the power station automation system which are networked together.

### BACKGROUND OF THE INVENTION

Process management systems or automation systems for the control and automation of power stations generally consist of numerous individual components. Apart from the field level, with the sensors and actuators, mention should be made of the automation devices with their I/O level, the networks with the communication processors and the operating and monitoring levels.

The engineering, operation and documentation of automation solutions calls for numerous work steps, the individual work steps generally being supported by software tools. These software tools, most of which have historically been developed and maintained over a long period of time, generally use different platforms, each with its own data storage. The documents and data are managed with the help of these heterogeneous data stocks (file systems, databases).

The documents and data are subject to frequent changes, for example over the course of a project (i.e. during planning, commissioning, operation and maintenance). In the case of current power station automation systems it is often no longer possible to understand these changes, which extend across the entire stock of data for a project, and earlier states of the work can often no longer be consistently reproduced.

At present, at least the changes in individual subsystems, which are mostly maintained on different platforms of the automation system, are managed by change indicators and by copies of the entire data stock for the subsystem. Change management and ensuring consistency for the overall system is effected with the help of additional lists, which are administered manually. The tracking of changes of a very detailed nature, for example the determination of the particular item of data or object which has been changed, or the determination of the individual who made the change, has until now only been possible in exceptional cases, because of the substantial effort.

Hence, taking an overall view, the solutions presently used for managing versions of the automation data do not therefore permit changes which have been made in the past to be adequately and reliably traced back. Consequently, a consistent recreation of earlier versions of the data or work states, as applicable, is often not possible.

### SUMMARY OF INVENTION

The object underlying the invention is to specify a method, for the management of versions of automation data for a power station automation system, which makes possible the unbroken tracing back and recreation of the versions of all the automation data which is held in different data stocks, generally on several platforms.

This object is inventively achieved with the method mentioned in the introduction for managing versions of automation data items, for a power station automation system, which are held in different data stocks on platforms of the power station automation system which are networked with each other, by which versions of at least one item of the automation data are exported in an interoperable format by means of a suitable tool, and the versions which are available in the form of an interoperable format are managed by means of a version management system.

In accordance with the invention, the data versions held in different data stocks are first exported in a uniform interoperable format, so that data versions which are initially held in different data stocks are available in the form of a uniform interoperable format, which makes it possible for the version management system, which can be a conventional configuration management system, to manage the data versions.

In accordance with the invention it is thus possible for the version management system to manage or process data versions in different data stocks after its exportation in a uniform interoperable format, for instance data recorded in the engineering of the power station automation, data from derived generation and compiler processes, relational databases, diagrams and bit maps, various file types, defining quantities for the data to be managed, and other data items such as standard data, the number of versions to be managed and the identification of project states, individual data items and objects.

With the uniformization thus applied to the data versions held in the different data stocks it is possible to realize unbroken tracing-back and recreation of the versions of all the automation data by means of the version management system.

With one advantageous development of the method in accordance with the invention, the versions which are available in the form of an interoperable format are stored away on an additional platform, which is networked with the platforms of the power station automation system and on which is held the version management system.

This advantageous additional formulation of the method in accordance with the invention makes it possible to avoid exposure of the functions which are transferred from the individual platforms of the automation system, such as for example the engineering or software engineering, to any influences from the version management system which might be disruptive, which might for example have a detrimental effect on the computing performance. The version management of the data versions, exported beforehand in an interoperable format by means of a suitable tool, such as an appropriate program, is carried out on another platform, for example in the form of a server, which is networked with the platforms of the power station automation system and on which is held the version management system.

In the case of another advantageous development of the method in accordance with the invention, the version management system manages exclusively versions of the automation data which are available in the form of source data.

By this means, the data volume to be managed by the version management system is limited in accordance with the invention to the source data recorded, which by comparison with previous known solutions for automation data version management brings significant advantages. Until now, version management for the data in a process management system or an automation system, as applicable, has hardly been possible due to the large volume, in particular, of derived and generated data. If however, as is provided in accordance with the invention, the data set to be managed is limited to the recorded source data, and if in addition it is exclusively the changes which are managed for the different versions, the data volume for version management can be handled.

Derived and generated data can be recreated at any point in time from the versioned source data, and therefore does not need to be included in the version management. In accordance with the invention, the state transitions for derived and generated data are managed during the generation, in order to determine which data source is used for the generation, which version the data source belongs to, what follow-on documents were generated and which data and what code was ultimately loaded into the target systems. Further, in accordance with the invention the error status of the generation and loading operations is also managed by means of the version management system.

In a practical development of the method in accordance with the invention, the version management system manages only a base version and the changes relative to earlier versions, so that with a further practical development of the method in accordance with the invention the version management system can determine an earlier version by using a base version and the changes compared to the base version, and then using a suitable tool the earlier version which has been determined can be converted to the original data stock, and can finally be imported.

In this way the data set which is to be managed by the version management system is, in accordance with the invention, restricted to a base version and changes, which implies a significant reduction in the incidence of data to be managed. For the purpose of recreating an earlier version of the data, the version management system starts from the base version and, preferably incrementally, tracks back through or reverses, as applicable, the changes which starting from the earlier version led to the base version. The earlier version thus determined in accordance with the invention can then be converted by means of a suitable tool, preferably in the form of a program or program subroutine, into the original data stock, and finally imported.

### BRIEF DESCRIPTION OF THE DRAWINGS

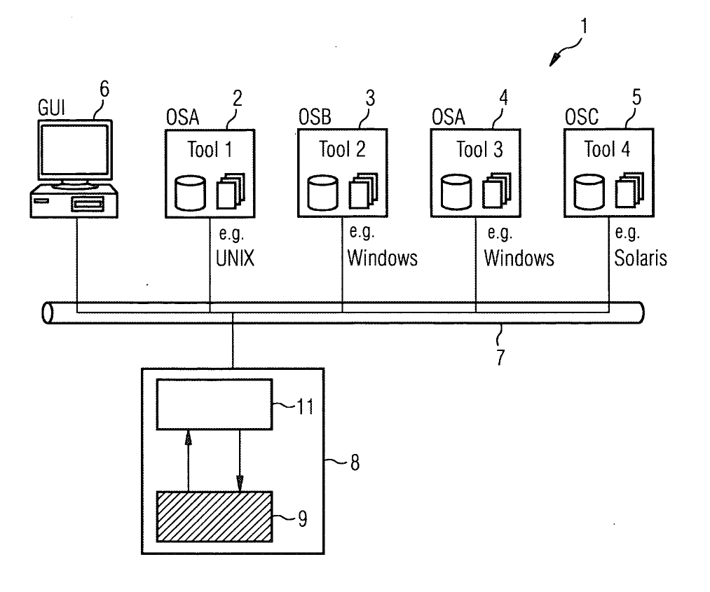

The method in accordance with the invention is explained in more detail below by reference to a power station automation system, in the form of an engineering system, shown schematically in FIG. 1.

### DETAILED DESCRIPTION OF INVENTION

The engineering system shown in FIG. 1 incorporates several platforms 2, 3, 4 and 5, which are networked with each other via a network 7, preferably of the Ethernet type. On each of the individual platforms 2, 3, 4 and 5 different functions are held, which will later be required in the target system for automating the operation of the power station.

So, for example, on platform 3 which takes the form of a personal computer with the Windows operating system, a Windows-based function of type TEC4 is held which is required for the technological engineering. Important items of data are held on platform 3 in a relational database, such as for example MS Access or MS SQL. In addition, data is held in a graphical format or in the HTML format, and further data in the Windows file system.

On the Unix-based platform 2, for example, a function is held for the creation of functional plans based on the technological engineering of the power station, and indeed preferably a function of the type ES680.

The greater part of the resulting engineering data is held in an Ingres database. The plant topology, and with it also the engineering of the entire networking of the plant, is undertaken with the help of an ES680 topological plan, with all the data being held in the Ingres data stock. In addition, using the ES680 topological plan, the automation hardware together with the assigned hardware deployment plans and module usage plans are defined and their uses assigned. Here again, all the relevant data items are held in the Ingres data stock.

Using an editor of the OM690 or OM650 type held on platform 4, the plant mimic diagrams and the process mimic diagrams are constricted and linked to the process as appropriate for their function. The data is stored in a Unix graphic data stock. Alternatively, for convenience in creating them a Windows-based OM editor can be used. The linkage to the process is generated by the system, on the basis of attributes. On platform 5 another function of the OM DAMO type is held.

The following platforms can be used: HP with HP-UX, PC with Windows, PC with SCO Unix, PC with DOS and SUN with Solaris.

The data volume occupied by the above functions is of the order of magnitude of a few hundred megabytes. Data volumes determined by way of example are 400 megabytes for the TEC4 function, 300 megabytes for the ES680 function, 250 megabytes for the OM function und 400 megabytes for the TEC4FDE function, with a resulting total data volume of 1.35 gigabytes. Version management for such a high data volume can only be realized by means of the inventive method, explained in more detail above, for the management of versions of automation data. For nuclear power plants, the estimated volumes of the data relevant for version management are even as high as about 8 gigabytes per version.

The monitor 6 which is shown is used to symbolize an appropriate graphical user interface (GUI), preferably of the CM4DCS type.

The individual platforms 2, 3, 4 and 5, and the graphical interface 6, are networked via the network 7 with a separate server 8 for version management of the data located on the individual platforms 2, 3, 4 and 5. Held on the server are a version management system 9 in the form of a conventional configuration management system and a programming interface 11 (API). After they have been exported in an interoperable format by means of a suitable software tool, data versions held in different data stocks on the individual platforms 2, 3, 4 and 5 are transferred for the purpose of version management into the version management system 9 held on the server 8.

The engineering system shown in FIG. 1 is an engineering system for a DCS (“distributed control system”), where the version management system 9 held on the server 8 in the form of a “configuration management system” has the following functions:
Addition of objects,
Removal of objects (only with special authorization),
Formation of object versions,
“Checking out” of a previous object version,
Comparison of object versions,
Formation of multi-system versions (i.e. objects from different functions or tools, as applicable),
Production of a version list for a DCS object,
Production of a version list for multi-system versions,
Production of a history for a DCS object,
Production of a history for a multi-system version, and
Transfer support.

The configuration management system 9 is based on the management of files and has interfaces for various operation system platforms (e.g. Windows or Unix). It is a separate utility program for the management of data versions, in particular the engineering data, for the functions (TEC4, ES680 and OM690) described above in more detail, and is based on the management of ASCII and binary files. The data held on the individual platforms 2, 3, 4 and 5, in particular engineering data (also referred to as DCS objects), are not generally available in the form of files, but are stored in databases. To enable the configuration management system 9 to manage the individual data versions, they must be available as files, in the form of ASCII or binary files. Hence the above functions (TEC4, ES680 and OM690) are designed to convert the appropriate database objects (i.e. in particular engineering data) into files in the form of ASCII or binary files, and to export them into a file system of the configuration management system 9, so that they are available to the configuration management system 9 for version management purposes. Codes identify and define the membership of a prescribed version or DCS object version, as applicable.

Processing of particular versions of engineering data (DCS objects) is effected using a working version, and making use of the above functions (TEC4, ES680 und OM690) held on the individual platforms 2, 3, 4 and 5. If the version to be processed is already contained in the configuration management system 9, it is first converted by means of a “check-out” function from the interoperable format (in the form of ASCII or binary files) into the original data stock and finally is imported into the associated database which is held on one of the platforms 2, 3, 4 and 5. The functions (TEC4, ES680 and OM690) held on the individual platforms 2, 3, 4 and 5 always work on a local copy. Here, it is possible to execute all the functions, including in particular consistency checks, for the version which has been released for processing.

Considered as a whole, the export/import of the application data, elucidated above, permits simpler data processing, where the configuration management system 9 enables different object versions to be compared and passes the resulting “delta” back to the individual functions (TEC4, ES680 and OM690).

1.-5. (canceled)

6. A method for the management of versions of automation data for a power station automation system, comprising:
holding versions of the automation data in different data stocks on a plurality of platforms of the power station automation system;
networking the plurality of platforms together;
exporting versions of at least one item of the automation data in an interoperable format via a suitable tool; and
managing the versions available in the interoperable format via a version management system.

7. The method as claimed in claim 6, wherein the versions available in the interoperable format are held on an additional platform, which is networked with the plurality of platforms of the power station automation system, along with the version management system.

8. The method as claimed in claim 7, wherein in the version management system manages exclusively versions which are available in the form of source data.

9. The method as claimed in claim 8, wherein the version management system manages only a base version and changes compared to earlier versions.

10. The method as claimed in claim 9, wherein the version management system determines an earlier version using a base version and the changes compared to the base version, and the earlier version determined is then converted via the suitable tool into the original data stock, and is finally imported.

11. A method for managing a plurality of automation data items of a power station automation system, comprising:
providing a plurality of different data stocks wherein the data stocks are network together and comprise a plurality of platforms;
providing a translation tool that translates versions of the automation data into a format that is interoperable among the plurality of networked platforms;
exporting versions of at least one data item of the automation data in the interoperable format; and
managing version of the data items available in the interoperable format via a version management system.

12. The method as claimed in claim 11, wherein the versions available in the interoperable format are held on an additional platform, which is networked with the plurality of platforms of the power station automation system, along with the version management system.

13. The method as claimed in claim 11, wherein in the version management system manages exclusively versions which are available in the form of source data.

14. The method as claimed in claim 11, wherein the version management system manages only a base version and changes compared to earlier versions.

15. The method as claimed in claim 11, wherein the version management system determines an earlier version using a base version and the changes compared to the base version, and the earlier version determined is then converted via the suitable tool into the original data stock, and is finally imported.
